(19) United States
(12) Patent Application Publication
(10) Pub. No.: US 2025/0135517 A1
(43) Pub. Date: May 1, 2025

(54) ELECTRODE ROLLING DEVICE

(71) Applicant: Prime Planet Energy & Solutions, Inc., Tokyo (JP)

(72) Inventors: Tetsumasa MARUO, Ibaraki-shi (JP); Norihisa ICHIKAWA, Gamagori-shi (JP)

(21) Appl. No.: 18/925,091

(22) Filed: Oct. 24, 2024

(30) Foreign Application Priority Data
Oct. 25, 2023 (JP) 2023-182892

(51) Int. Cl. B21B 37/38; B21B 29/00; B21B 38/04; H01M 4/04

(52) U.S. Cl. CPC B21B 37/38; B21B 29/00; B21B 38/04; H01M 4/0435; B21B 2261/04; B21B 2269/04

(57) ABSTRACT

An electrode rolling device acquires thicknesses of an electrode sheet, Tc at a center portion in a width direction, Twe at an end portion on a first side, Tde at an end portion on a second side, Twc at a first intermediate portion, which is set between the center portion and the end portion on the first side, and Tdc at a second intermediate portion, which is set between the center portion and the end portion on the second side. The electrode rolling device determines a deviation ΔTwe between the thickness Tc and Twe, a deviation ΔTwc between the thickness Tc and Twc, a deviation ΔTde between the thickness Tc and Tde, and a deviation ΔTdc between the thickness Tc and Tdc, and performs control so as to reduce the deviation ΔTwe or ΔTwc, whichever is larger, and to reduce the deviation ΔTde or ΔTdc, whichever is larger.

### CROSS-REFERENCE TO RELATED APPLICATION

This application claims the benefit of priority to Japanese Patent Application No. 2023-182892 filed on Oct. 25, 2023, and the entire contents of this application are hereby incorporated herein by reference.

### BACKGROUND OF THE DISCLOSURE

### 1. Field

The present invention relates to an electrode rolling device.

### 2. Background

Japanese Patent No. 5328876, for example, discloses a roll press machine that rolls materials, such as electrode materials for lithium ion secondary batteries. The roll press machine disclosed in Japanese Patent No. 5328876 includes an upper roll and a lower roll, a press cylinder configured to generate a press load between the upper roll and the lower roll, a roll drive mechanism, a bending cylinder configured to correct deflection of the rolls, and a thickness meter configured to measure thicknesses of a material at three points, that is, at the center of the material in the width direction, on the roll drive mechanism side (drive side), and the side on which the roll drive mechanism is not disposed (manipulation side). The roll press machine disclosed in Japanese Patent No. 5328876 is configured such that, when a difference between a target thickness and the material thickness falls outside the threshold value, feedback control for the press cylinder and feedback control for the bending cylinder are performed solely or in combination. To be more specific, in the roll press machine disclosed in Japanese Patent No. 5328876, the pressing pressure of the press cylinder is controlled when the material thickness on the drive side or the manipulation side falls outside the threshold value, and the bending pressure of the bending cylinder is controlled when the material thicknesses on the drive side and the manipulation side are inside the threshold value, and the material thickness at the center falls outside the threshold value.

International Publication No. WO 2021/140747 also discloses a roll press device having a configuration similar to the configuration of the roll press machine disclosed in Japanese Patent No. 5328876. The roll press device disclosed in International Publication No. WO 2021/140747 is configured to determine a difference between the target value of the thickness and the measured value of the thickness on the drive side, a difference between the target value of the thickness and the measured value of the thickness on the manipulation side, and a difference between the measured value of the thickness at the center and the average thickness between the measured value on the drive side and the measured value on the manipulation side. In the roll press device disclosed in International Publication No. WO 2021/140747, the above-mentioned calculated three differences are applied to the predetermined calculation formula to set pressures for a press cylinder on the drive side, for the press cylinder on the manipulation side, for the bending cylinder on the drive side, and for the bending cylinder on the manipulation side.

A roll press device disclosed in International Publication No. WO 2020/100561 is configured to determine a difference between the target value of the thickness and the measured value of the thickness at the center, a difference between the measured value of the thickness at the center and the average thickness between the measured value on the drive side and the measured value on the manipulation side, and a difference between the measured value of the thickness on the drive side and the measured value of the thickness on the manipulation side. In the roll press device disclosed in International Publication No. WO 2020/100561, the above-mentioned calculated three differences are applied to the predetermined calculation formula to set the pressures for a press cylinder on the drive side, for the press cylinder on the manipulation side, for the bending cylinder on the drive side, and for the bending cylinder on the manipulation side. According to International Publication No. WO 2020/100561, such control can increase the accuracy of thickness control of the roll press device.

### SUMMARY

The roll press devices described in these literatures perform control assuming that the thickness of the electrode sheet gently changes such that an intrusion or a recess is formed at the center portion. However, there may be cases in which the thickness of the electrode sheet changes such that the electrode sheet undulates along the width direction. The present disclosure proposes an electrode rolling device that can, even when the electrode sheet undulates along the width direction, reduce variation in thickness of the electrode sheet along the width direction.

An electrode rolling device disclosed herein includes: a conveyance device configured to convey, along a predetermined conveyance path, an electrode sheet which has a strip shape and on which an electrode active material layer is formed; a rolling device disposed in the predetermined conveyance path, and configured to roll the electrode sheet; and a controller. The rolling device includes a pair of rolling rolls allowing the electrode sheet to be interposed therebetween, a first gap adjusting mechanism configured to adjust a gap between the pair of rolling rolls on a first side of the pair of rolling rolls in a width direction, a second gap adjusting mechanism configured to adjust the gap between the pair of rolling rolls on a second side of the pair of rolling rolls in the width direction, a first bending mechanism configured to rectify deflection of the pair of rolling rolls on the first side of the pair of rolling rolls in the width direction, and a second bending mechanism configured to rectify the deflection of the pair of rolling rolls on the second side of the pair of rolling rolls in the width direction. The controller acquires, with respect to the electrode sheet, a thickness Tc at a center portion in the width direction, a thickness Twe at an end portion on the first side, a thickness Tde at an end portion on the second side, a thickness Twc at a first intermediate portion, which is set between the center portion and the end portion on the first side, and a thickness Tdc at a second intermediate portion, which is set between the center portion and the end portion on the second side. The controller determines a deviation ΔTwe between the thickness Tc at the center portion and the thickness Twe at the end portion on the first side, and a deviation ΔTwc between the thickness Tc at the center portion and the thickness Twc at the first intermediate portion, and determines a deviation ΔTde between the thickness Tc at the center portion and the thickness Tde at the end portion on the second side, and a deviation ΔTdc between the thickness Tc at the center portion and the thickness Tdc at the second intermediate portion. The controller controls the first gap adjusting mechanism, the second gap adjusting mechanism, the first bending mechanism, and the second bending mechanism in such a way as to reduce the deviation ΔTwe or the deviation ΔTwc, whichever is larger, and to reduce the deviation ΔTde or the deviation ΔTdc, whichever is larger.

According to the above-mentioned electrode rolling device, the first gap adjusting mechanism, the second gap adjusting mechanism, the first bending mechanism, and the second bending mechanism are controlled in such a way as to reduce whichever is the larger of the deviation ΔTwe or the deviation ΔTwc, and whichever is the larger of the deviation ΔTde or the deviation ΔTdc. ΔTwe is the deviation between the thickness Tc of the electrode sheet at the center portion in the width direction and the thickness Twe at the end portion on the first side. ΔTwc is the deviation between the thickness Tc at the center portion and the thickness Twc at the first intermediate portion. ΔTde is the deviation between the thickness Tc at the center portion and the thickness Tde at the end portion on the second side. ΔTdc is the deviation between the thickness Tc at the center portion and the thickness Tdc at the second intermediate portion. Therefore, even when the electrode sheet has a large thickness or a small thickness at the first intermediate portion or the second intermediate portion due to undulation, it is possible to reduce variation in thickness of the electrode sheet along the width direction.

### BRIEF DESCRIPTION OF THE DRAWINGS

FIG. 1 is a schematic side view of an electrode rolling device.

FIG. 2 is a schematic front view of the electrode rolling device.

FIG. 3 is a schematic plan view of the electrode rolling device.

FIG. 4 is a control block diagram of the electrode rolling device.

FIG. 5 is a flowchart showing the flow of feedback control for the thickness of an electrode sheet.

FIG. 6 is a schematic view showing distribution patterns of the thickness of the electrode sheet according to the position in the width direction.

FIG. 7 is a graph showing the maximum deviation of the thickness of the electrode sheet.

### DETAILED DESCRIPTION OF THE PREFERRED EMBODIMENTS

Hereinafter, one embodiment of an electrode rolling device for an electricity storage device will be described. The embodiment described herein does not particularly intend to limit the present invention. Respective drawings are schematic views, and actual implementations are not always faithfully reflected.

### [Configuration of Electrode Rolling Device]

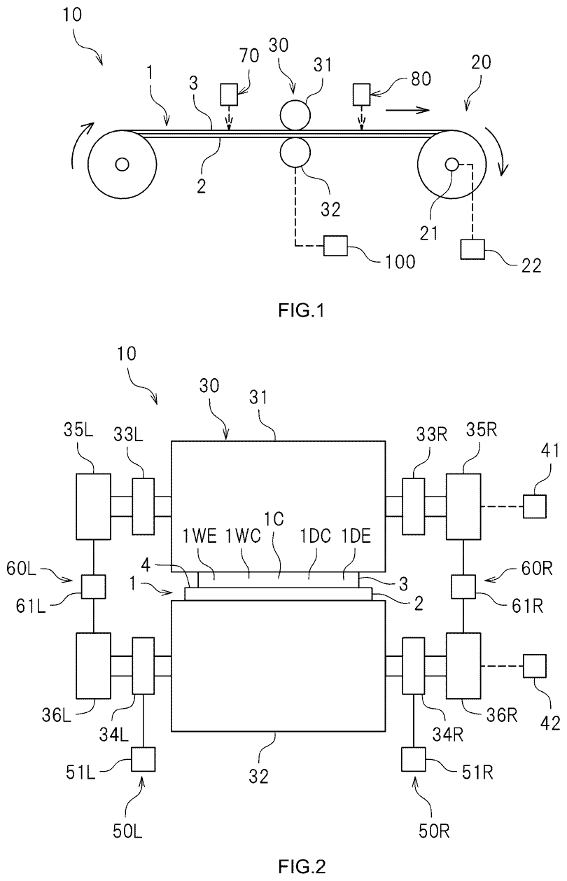

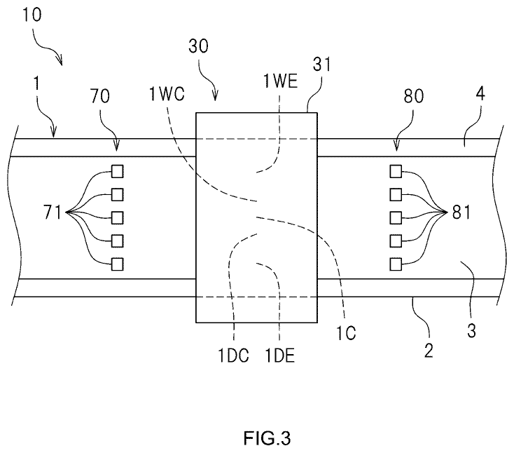

FIG. 1 is a schematic side view of an electrode rolling device 10 according to one embodiment. FIG. 2 is a schematic front view of the electrode rolling device 10. FIG. 3 is a schematic plan view of the electrode rolling device 10. The electrode rolling device 10 rolls an electrode sheet 1, which has a strip shape and on which an electrode active material layer 3 is formed, to cause the thickness of the electrode sheet 1 to fall within a predetermined range. In the present embodiment, the electrode sheet 1 is the electrode sheet of a lithium ion secondary battery. However, the electrode sheet 1 is not limited to the electrode sheet of a lithium ion secondary battery, and may be the electrode sheet of any kind of various known electricity storage devices. An electricity storage device is a term indicating a general device that can extract electrical energy. The electricity storage device includes a so-called storage battery (chemical battery), such as a lithium ion secondary battery and a nickel-hydrogen battery, and a capacitor (physical battery), such as an electric double layer capacitor.

As shown in FIG. 3, the electrode sheet 1 includes a current collecting foil 2 having a strip shape, and the electrode active material layer 3 formed on the current collecting foil 2. Of the current collecting foil 2, a portion where the electrode active material layer 3 is not formed forms a non-formed part 4. A positive electrode sheet is a member in which the positive electrode active material layer 3 containing a positive electrode active material is formed on the surface of the current collecting foil 2 (an aluminum foil, for example) having a strip shape and having a predetermined width and a predetermined thickness. In a lithium ion secondary battery, the positive electrode active material is a material that can emit lithium ions during charging, and that can absorb lithium ions during discharge, as a lithium transition metal composite material, for example. In the positive electrode sheet, the electrode active material layer 3 and the non-formed part 4 are protected by a protective layer. A negative electrode sheet is a member in which a negative electrode active material layer 3 containing a negative electrode active material is formed on the surface of the current collecting foil 2 (a copper foil, for example) having a strip shape and having a predetermined width and a predetermined thickness. In a lithium ion secondary battery, the negative electrode active material is a material that can occlude lithium ions during charging, and that can emit, during discharge, lithium ions occluded during charging, as a natural graphite, for example. Various active materials besides the above-mentioned materials are also proposed for the positive electrode active material and the negative electrode active material, and the positive electrode active material and the negative electrode active material are not particularly limited.

As shown in FIG. 1, the electrode rolling device 10 includes a conveyance device 20, a roll press machine 30, an upstream-side thickness measuring device 70, a downstream-side thickness measuring device 80, and a control device 100. Although the electrode rolling device 10 may additionally include an inspection device and the like, the description and the illustration of such devices will be omitted in the present embodiment.

The conveyance device 20 conveys the electrode sheet 1 in the longitudinal direction along a predetermined conveyance path. In the present embodiment, the conveyance device 20 includes a winding device 21 disposed on the most downstream side in the electrode rolling device 10, and configured to wind up the rolled electrode sheet 1. The electrode sheet 1 having a strip shape is wound up by the winding device 21, thus being conveyed in the longitudinal direction. The conveyance device 20 is configured to be capable of measuring and adjusting the speed at which the electrode sheet 1 is conveyed. The winding device 21 includes an encoder 22 that reads the rotation angle. The speed at which the electrode sheet 1 is conveyed is calculated from the rotation angle of the winding device 21, which is read by the encoder 22. The winding device 21 is configured such that the rotational speed thereof is controllable. However, the configuration of the conveyance device 20 is not limited to the above-mentioned configuration.

The roll press machine 30 is disposed in the conveyance path for the electrode sheet 1. The roll press machine 30 rolls the electrode sheet 1. As shown in FIG. 2, the roll press machine 30 includes a pair of rolling rolls 31, 32 allowing the electrode sheet 1 to be interposed therebetween. In the present embodiment, the pair of rolling rolls 31, 32 is formed of an upper roll 31 and a lower roll 32. Each of the upper roll 31 and the lower roll 32 has a columnar shape, and extends in the width direction of the electrode sheet 1. Hereinafter, for the sake of convenience, the width direction of the electrode sheet 1 (left-right direction in FIG. 2) is also referred to as “left-right direction”, and the left side and the right side in FIG. 2 are also referred to as the left side and the right side of the roll press machine 30.

The upper roll 31 is supported by a left bearing 33L and a right bearing 33R in such a way as to be rotatable in the front-rear direction. The lower roll 32 is supported by a left bearing 34L and a right bearing 34R in such a way as to be rotatable in the front-rear direction. The roll press machine 30 includes an upper roll rotating device 41 and a lower roll rotating device 42, the upper roll rotating device 41 rotating the upper roll 31 in the front-rear direction, the lower roll rotating device 42 rotating the lower roll 32 in the front-rear direction. The upper roll rotating device 41 is configured to be capable of controlling the rotational speed of the upper roll 31. The lower roll rotating device 42 is configured to be capable of controlling the rotational speed of the lower roll 32. Hereinafter, in reference to the extending direction of the rolling rolls 31, 32 (the width direction of the electrode sheet 1), the side on which the upper roll rotating device 41 and the lower roll rotating device 42 are disposed is also referred to as “drive side”, and the side opposite to the drive side is also referred to as “work side”. In the present embodiment, the drive side is the right side, and the work side is the left side.

As shown in FIG. 2, the roll press machine 30 includes a first gap adjusting mechanism 50L and a second gap adjusting mechanism 50R, the first gap adjusting mechanism 50L adjusting a gap between the pair of rolling rolls 31, 32 on the work side of the pair of rolling rolls 31, 32, the second gap adjusting mechanism 50R adjusting a gap between the pair of rolling rolls 31, 32 on the drive side of the pair of rolling rolls 31, 32. The roll press machine 30 further includes a first bending mechanism 60L and a second bending mechanism 60R, the first bending mechanism 60L rectifying deflection of the pair of rolling rolls 31, 32 on the work side of the pair of rolling rolls 31, 32, the second bending mechanism 60R rectifying deflection of the pair of rolling rolls 31, 32 on the drive side of the pair of rolling rolls 31, 32. The work side is an example of the first side in the width direction of the electrode sheet 1. The drive side is an example of the second side in the width direction of the electrode sheet 1.

As shown in FIG. 2, in the present embodiment, the first gap adjusting mechanism 50L includes a first press cylinder 51L that moves the left bearing 34L of the lower roll 32 in the up-down direction. The first press cylinder 51L generates a press load between a portion of the upper roll 31 on the work side and a portion of the lower roll 32 on the work side. The first gap adjusting mechanism 50L adjusts the gap on the work side of the pair of rolling rolls 31, 32 by adjusting the press load. The second gap adjusting mechanism 50R includes a second press cylinder 51R that moves the right bearing 34R of the lower roll 32 in the up-down direction. The second press cylinder 51R generates a press load between a portion of the upper roll 31 on the drive side and a portion of the lower roll 32 on the drive side. The second gap adjusting mechanism 50R adjusts the gap on the drive side of the pair of rolling rolls 31, 32 by adjusting the press load.

The first bending mechanism 60L includes a first bending cylinder 61L that applies, between the portion of the upper roll 31 on the work side and the portion of the lower roll 32 on the work side, forces in directions for separating the upper roll 31 and the lower roll 32 from each other. By adjusting the forces applied by the first bending cylinder 61L, it is possible to rectify or cause deflection at the portion of the upper roll 31 on the work side and at the portion of the lower roll 32 on the work side. The first bending mechanism 60L is configured to change the gap between the pair of rolling rolls 31, 32 at an end portion on the work side. The roll press machine 30 includes a left bending bearing 35L and a right bending bearing 35R, the left bending bearing 35L being disposed leftward of the left bearing 33L of the upper roll 31, and rotatably supporting the upper roll 31, the right bending bearing 35R being disposed rightward of the right bearing 33R, and rotatably supporting the upper roll 31. The roll press machine 30 also includes a left bending bearing 36L and a right bending bearing 36R, the left bending bearing 36L being disposed leftward of the left bearing 34L of the lower roll 32, and rotatably supporting the lower roll 32, the right bending bearing 36R being disposed rightward of the right bearing 34R, and rotatably supporting the lower roll 32. The first bending cylinder 61L is configured to apply, to the left bending bearing 35L of the upper roll 31 and the left bending bearing 36L of the lower roll 32, forces in directions for separating the left bending bearing 35L and the left bending bearing 36L from each other.

The second bending mechanism 60R includes a second bending cylinder 61R that applies, between the portion of the upper roll 31 on the drive side and the portion of the lower roll 32 on the drive side, loads in directions for separating the upper roll 31 and the lower roll 32 from each other. By adjusting the loads applied by the second bending cylinder 61R, it is possible to rectify or cause deflection at the portion of the upper roll 31 on the drive side and at the portion of the lower roll 32 on the drive side. The second bending mechanism 60R is configured to change the gap between the pair of rolling rolls 31, 32 at an end portion on the drive side. The second bending cylinder 61R is configured to apply, to the right bending bearing 35R of the upper roll 31 and the right bending bearing 36R of the lower roll 32, forces in directions for separating the right bending bearing 35R and the right bending bearing 36R from each other.

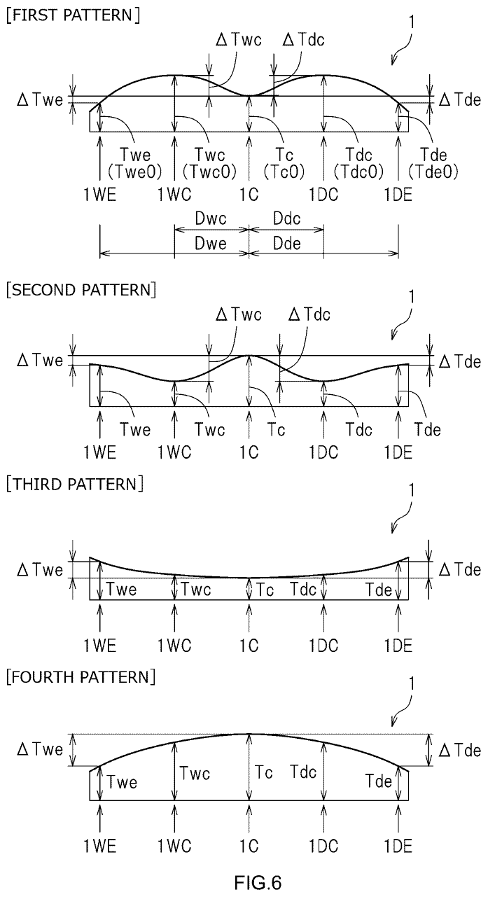

As shown in FIG. 3, the upstream-side thickness measuring device 70 measures, in the conveyance path, the thicknesses of the electrode sheet 1 at a position upstream of the roll press machine 30. The upstream-side thickness measuring device 70 measures the thicknesses of the electrode sheet 1 before the electrode sheet 1 is rolled by the roll press machine 30. The upstream-side thickness measuring device 70 measures the thicknesses of the electrode sheet 1 at five points in different positions in the width direction of the electrode sheet 1. To be more specific, the upstream-side thickness measuring device 70 measures, with respect to the electrode sheet 1 before rolling, a thickness Tc0 at a center portion 1C, a thickness Twe0 at an end portion 1WE on the work side, a thickness Tde0 at an end portion 1DE on the drive side, a thickness Twc0 at a first intermediate portion 1WC, which is set between the center portion 1C and the end portion 1WE on the work side, and a thickness Tdc0 at a second intermediate portion 1DC, which is set between the center portion 1C and the end portion 1DE on the drive side (see FIG. 6 for these thicknesses, but these thicknesses are only shown in [first pattern] in FIG. 6 with parentheses). In the present embodiment, the upstream-side thickness measuring device 70 includes five non-contact displacement sensors 71 provided above the center portion 1C, the end portion 1WE on the work side, the end portion 1DE on the drive side, the first intermediate portion 1WC, and the second intermediate portion 1DC of the electrode sheet 1. However, the configuration of the upstream-side thickness measuring device 70 is not particularly limited.

As shown in FIG. 3, the downstream-side thickness measuring device 80 measures, in the conveyance path, the thicknesses of the electrode sheet 1 at a position downstream of the roll press machine 30. The downstream-side thickness measuring device 80 measures the thicknesses of the electrode sheet 1 after the electrode sheet 1 is rolled by the roll press machine 30. The downstream-side thickness measuring device 80 also measures the thicknesses of the electrode sheet 1 at the same five points as the upstream-side thickness measuring device 70. That is, the downstream-side thickness measuring device 80 measures, with respect to the electrode sheet 1 after rolling, a thickness Tc at the center portion 1C, a thickness Twe at the end portion 1WE on the work side, a thickness Tde at the end portion 1DE on the drive side, a thickness Twc at the first intermediate portion 1WC, and a thickness Tdc at the second intermediate portion 1DC (see FIG. 6 for these thicknesses, reference signs denoting thicknesses after rolling are differentiated from the reference signs denoting the thicknesses before rolling). In the present embodiment, the downstream-side thickness measuring device 80 includes five non-contact displacement sensors 81 provided above the center portion 1C, the end portion 1WE on the work side, the end portion 1DE on the drive side, the first intermediate portion 1WC, and the second intermediate portion 1DC of the electrode sheet 1. However, the configuration of the downstream-side thickness measuring device 80 is also not particularly limited.

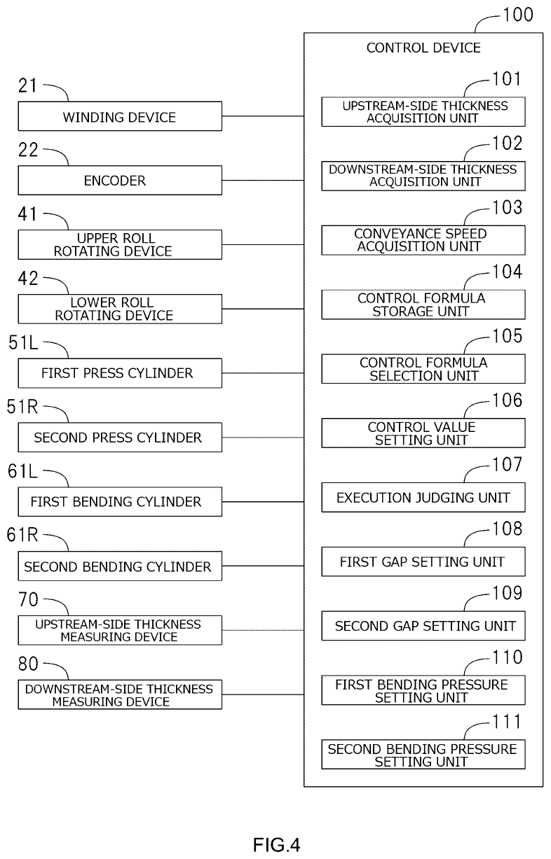

FIG. 4 is a control block diagram of the electrode rolling device 10. As shown in FIG. 4, the control device 100 of the electrode rolling device 10 is connected to the winding device 21 of the conveyance device 20, the upper roll rotating device 41, the lower roll rotating device 42, the first press cylinder 51L, the second press cylinder 51R, the first bending cylinder 61L, and the second bending cylinder 61R, and controls actions of these components. The control device 100 is also connected to the encoder 22 of the conveyance device 20, the upstream-side thickness measuring device 70, and the downstream-side thickness measuring device 80, and receives signals from these components.

The configuration of the control device 100 is not particularly limited. The control device 100 includes a microcomputer, for example. The microcomputer may include, for example, an interface (I/F) that receives data or the like from external equipment, a central processing unit (CPU) that executes instructions of a program, a read only memory (ROM) that stores the program to be executed by the CPU, a random access memory (RAM) that is used as a working area for developing the program, and a storage device that stores the above-mentioned program and various data, such as a memory.

As shown in FIG. 4, the control device 100 includes an upstream-side thickness acquisition unit 101, a downstream-side thickness acquisition unit 102, a conveyance speed acquisition unit 103, a control formula storage unit 104, a control formula selection unit 105, a control value setting unit 106, an execution judging unit 107, a first gap setting unit 108, a second gap setting unit 109, a first bending pressure setting unit 110, and a second bending pressure setting unit 111.

The upstream-side thickness acquisition unit 101 acquires the thicknesses of the electrode sheet 1, which are measured by the upstream-side thickness measuring device 70. The upstream-side thickness acquisition unit 101 acquires, with respect to the electrode sheet 1 before rolling, the thickness Tc0 at the center portion 1C in the width direction, the thickness Twe0 at the end portion 1WE on the work side, the thickness Tde0 at the end portion 1DE on the drive side, the thickness Twc0 at the first intermediate portion 1WC, and the thickness Tdc0 at the second intermediate portion 1DC.

The downstream-side thickness acquisition unit 102 acquires the thicknesses of the electrode sheet 1, which are measured by the downstream-side thickness measuring device 80. The downstream-side thickness acquisition unit 102 acquires, with respect to the electrode sheet 1 after rolling, the thickness Tc at the center portion 1C in the width direction, the thickness Twe at the end portion 1WE on the work side, the thickness Tde at the end portion 1DE on the drive side, the thickness Twc at the first intermediate portion 1WC, and the thickness Tdc at the second intermediate portion 1DC.

The conveyance speed acquisition unit 103 acquires the conveyance speed of the electrode sheet 1, which is measured by the encoder 22.

The control formula storage unit 104 stores a first control formula to an eighth control formula that calculate control values for the first press cylinder 51L, the second press cylinder 51R, the first bending cylinder 61L, and the second bending cylinder 61R. A control formula to be used is selected from the first control formula to the eighth control formula according to thickness distribution along the width direction of the electrode sheet 1.

The first control formula is a control formula used when Twc>Tc and Twc>Twe are established. The first control formula determines control values that control the first gap adjusting mechanism 50L and the first bending mechanism 60L. When Twc>Tc and Twc>Twe are established, the thickness Twc at the first intermediate portion 1WC is larger than the thickness Tc at the center portion 1C and the thickness Twe at the end portion 1WE on the work side. That is, the electrode sheet 1 undulates on the work side such that a protrusion is formed at the first intermediate portion 1WC (see [first pattern] in FIG. 6).

When the distance in the width direction between the center portion 1C and the end portion 1WE on the work side is taken as “Dwe”, and the distance in the width direction between the center portion 1C and the first intermediate portion 1WC is taken as “Dwc” (see FIG. 6), the first control formula includes a formula that determined a corrected deviation ΔTw=ΔTwc×Dwc/Dwe. ΔTwc denotes a deviation between the thickness Tc after rolling at the center portion 1C and the thickness Twc after rolling at the first intermediate portion 1WC, and is the absolute value of (Twc-Tc) in the present embodiment. Assume in the present specification that each of the deviations ΔTw and ΔTwc is the absolute value of the difference, that is, a positive value. Hereinafter, the same applies for the description of “deviation”, “difference” and the like. Accordingly, a comparison of the magnitude of deviation is made by comparing absolute values. However, deviation may be defined as a value with a positive or negative sign and, in such a case, the description in the present specification can be considered to be suitably changed to conform with the definition. Hereinafter, “ΔTwe” denotes a deviation between the thickness Tc after rolling at the center portion 1C and the thickness Twe after rolling at the end portion 1WE on the work side, and is the absolute value of (Twe-Tc) in the present embodiment.

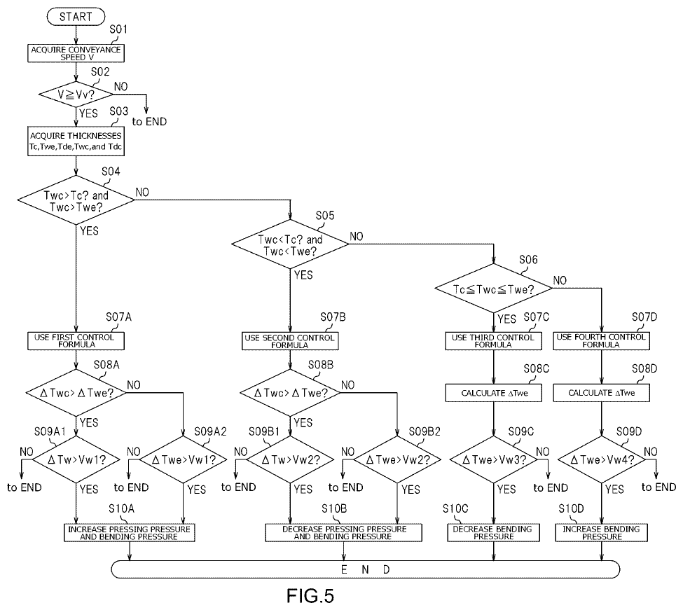

For the first control formula, when the deviation ΔTwc is larger than the deviation ΔTwe, and the corrected deviation ΔTw=ΔTwc×Dwc/Dwe is more than a predetermined threshold value Vw1 (see FIG. 5), or when the deviation ΔTwe is equal to or more than the deviation ΔTwc, and the deviation ΔTwe is more than the threshold value Vw1, the first control formula is configured to set the control value for the first gap adjusting mechanism 50L and the control value for the first bending mechanism 60L, the control value for the first gap adjusting mechanism 50L decreasing the gap between the pair of rolling rolls 31, 32 on the work side, the control value for the first bending mechanism 60L increasing the gap between the pair of rolling rolls 31, 32 at the end portion 1WE on the work side.

In the present embodiment, when the deviation ΔTwe or the corrected deviation ΔTw is more than the threshold value Vw1, the first control formula increases the pressing pressure of the first press cylinder 51L by a predetermined pressure over the pressing pressure being applied up to that point in time. In this case, the first control formula also increases the bending pressure of the first bending cylinder 61L by a predetermined pressure over the bending pressure being applied up to that point in time. When Twc>Tc and Twc>Twe are established, the control formula selection unit 105 selects the first control formula as the control formula that sets the control values for the first press cylinder 51L and the first bending cylinder 61L. The first gap setting unit 108 controls the pressing pressure of the first press cylinder 51L such that the set pressing pressure is obtained. The first bending pressure setting unit 110 controls the bending pressure of the first bending cylinder 61L such that the set bending pressure is obtained. The control device 100 repeats this feedback control until eliminating the state in which the deviation ΔTwe or the corrected deviation ΔTw is more than the threshold value Vw1.

The second control formula is a control formula used when Twc<Tc and Twc<Twe are established. The second control formula determines control values that control the first gap adjusting mechanism 50L and the first bending mechanism 60L. When Twc<Tc and Twc<Twe are established, the thickness Twc at the first intermediate portion 1WC is smaller than the thickness Tc at the center portion 1C and the thickness Twe at the end portion 1WE on the work side. That is, the electrode sheet 1 undulates on the work side such that a recess is formed at the first intermediate portion 1WC (see [second pattern] in FIG. 6).

For the second control formula, when the deviation ΔTwc is larger than the deviation ΔTwe, and the corrected deviation ΔTw=ΔTwc×Dwc/Dwe is more than a predetermined threshold value Vw2 (see FIG. 5), or when the deviation ΔTwe is equal to or more than the deviation ΔTwc, and the deviation ΔTwe is more than the threshold value Vw2, the second control formula is configured to set the control value for the first gap adjusting mechanism 50L and the control value for the first bending mechanism 60L, the control value for the first gap adjusting mechanism 50L increasing the gap between the pair of rolling rolls 31, 32 on the work side, the control value for the first bending mechanism 60L decreasing the gap between the pair of rolling rolls 31, 32 at the end portion 1WE on the work side. Feedback control that uses the second control formula is substantially equal to that for the case of using the first control formula. The same applies for cases of using other control formulae. The threshold value Vw2 may be equal to or different from the threshold value Vw1.

The third control formula is a control formula used when Tc≤Twc≤Twe is established. The third control formula determines control values that control the first gap adjusting mechanism 50L and the first bending mechanism 60L. When Tc≤Twc≤Twe is established, the thickness of the electrode sheet 1 on the work side is the smallest at the center portion 1C, and increases with the increase in distance from the center portion 1C, that is, in order of the first intermediate portion 1WC and then the end portion 1WE on the work side (see [third pattern] in FIG. 6).

For the third control formula, when the deviation ΔTwe between the thickness Tc at the center portion 1C and the thickness Twe at the end portion 1WE on the work side is more than a predetermined threshold value Vw3 (see FIG. 5), the third control formula is configured to set the control value for the first bending mechanism 60L, the control value for the first bending mechanism 60L decreasing the gap between the pair of rolling rolls 31, 32 at the end portion 1WE on the work side.

The fourth control formula is a control formula used when Tc≥Twc≥Twe is established. The fourth control formula determines control values that control the first gap adjusting mechanism 50L and the first bending mechanism 60L. When Tc≥Twc≥Twe is established, the thickness of the electrode sheet 1 on the work side is the largest at the center portion 1C, and decreases with the increase in distance from the center portion 1C, that is, in order of the first intermediate portion 1WC and then the end portion 1WE on the work side (see [fourth pattern] in FIG. 6).

For the fourth control formula, when the deviation ΔTwe between the thickness Tc at the center portion 1C and the thickness Twe at the end portion 1WE on the work side is more than a predetermined threshold value Vw4 (see FIG. 5), the fourth control formula is configured to set the control value for the first bending mechanism 60L, the control value for the first bending mechanism 60L increasing the gap between the pair of rolling rolls 31, 32 at the end portion 1WE on the work side.

As described above, the first control formula to the fourth control formula are control formulae for rectifying variation in thickness of the electrode sheet 1 on the work side. The first control formula to the fourth control formula are respectively used in a first case, a second case, a third case, and a fourth case. In the first case, the electrode sheet 1 undulates such that a protrusion is formed at the first intermediate portion 1WC. In the second case, the electrode sheet 1 undulates such that a recess is formed at the first intermediate portion 1WC. In the third case, the thickness of the electrode sheet 1 increases toward the end portion 1WE on the work side. In the fourth case, the thickness of the electrode sheet 1 decreases toward the end portion 1WE on the work side. The control device 100 compares the measured values of the thickness Tc at the center portion 1C, the thickness Twe at the end portion 1WE on the work side, and the thickness Twc at the first intermediate portion 1WC and, based on the comparison result, judges which control formula of the first control formula to the fourth control formula should be used. The control device 100 determines the deviation ΔTwe between the thickness Tc at the center portion 1C and the thickness Twe at the end portion 1WE on the work side, and the deviation ΔTwc between the thickness Tc at the center portion 1C and the thickness Twc at the first intermediate portion 1WC. As described above, when any of the first control formula to the fourth control formula is used, the control device 100 controls the first gap adjusting mechanism 50L and the first bending mechanism 60L in such a way as to reduce the deviation ΔTwe or the deviation ΔTwc, whichever is larger.

The fifth control formula to the eighth control formula are control formulae for rectifying variation in thickness of the electrode sheet 1 on the drive side, and respectively correspond to the first control formula to the fourth control formula, which are the control formulae for the work side.

The fifth control formula is a control formula used when Tdc>Tc and Tdc>Tde are established. The fifth control formula determines control values that control the second gap adjusting mechanism 50R and the second bending mechanism 60R. When Tdc>Tc and Tdc>Tde are established, the thickness Tdc at the second intermediate portion 1DC is larger than the thickness Tc at the center portion 1C and the thickness Tde at the end portion 1DE on the drive side. That is, the electrode sheet 1 undulates on the drive side such that a protrusion is formed at the second intermediate portion 1DC (see [first pattern] in FIG. 6). Although not shown in the drawing, the work side and the drive side of the electrode sheet 1 may differ from each other in variation in thickness (whether the electrode sheet 1 undulates such that a protrusion or a recess is formed at the intermediate portion, or the thickness of the electrode sheet 1 increases or decreases toward the end portion).

When the distance in the width direction between the center portion 1C and the end portion 1DE on the drive side is taken as “Dde”, and the distance in the width direction between the center portion 1C and the second intermediate portion 1DC is taken as “Ddc” (see FIG. 6), the fifth control formula includes a formula that determines the corrected deviation ΔTd=ΔTdc×Ddc/Dde. ΔTdc denotes a deviation between the thickness Tc after rolling at the center portion 1C and the thickness Tdc after rolling at the second intermediate portion 1DC, and is the absolute value of (Tdc-Tc) in the present embodiment. Hereinafter, ΔTde denotes a deviation between the thickness Tc after rolling at the center portion 1C and the thickness Tde after rolling at the end portion 1DE on the drive side, and is the absolute value of (Tde-Tc) in the present embodiment.

For the fifth control formula, when the deviation ΔTdc is larger than the deviation ΔTde, and the corrected deviation ΔTd=ΔTdc×Ddc/Dde is more than the predetermined threshold value, or when the deviation ΔTde is equal to or more than the deviation ΔTdc, and the deviation ΔTde is more than the threshold value, the fifth control formula is configured to set the control value for the second gap adjusting mechanism 50R and the control value for the second bending mechanism 60R, the control value for the second gap adjusting mechanism 50R decreasing the gap between the pair of rolling rolls 31, 32 on the drive side, the control value for the second bending mechanism 60R increasing the gap between the pair of rolling rolls 31, 32 at the end portion 1DE on the drive side. The threshold value for the drive side may be equal to or different from the threshold value Vw1 for the work side. When the deviation ΔTdc is larger than the deviation ΔTde, and the corrected deviation ΔTd=ΔTdc×Ddc/Dde is more than the predetermined threshold value, or when the deviation ΔTde is equal to or more than the deviation ΔTdc, and the deviation ΔTde is more than the threshold value, the fifth control formula increases the pressing pressure of the second press cylinder 51R by a predetermined pressure over the pressing pressure being applied up to that point in time. In this case, the fifth control formula also increases the bending pressure of the second bending cylinder 61R by a predetermined pressure over the bending pressure being applied up to that point in time. When Tdc>Tc and Tdc>Tde are established, the control formula selection unit 105 selects the fifth control formula as the control formula that sets control values for the second press cylinder 51R and the second bending cylinder 61R. The second gap setting unit 109 controls the pressing pressure of the second press cylinder 51R such that the set pressing pressure is obtained. The second bending pressure setting unit 111 controls the bending pressure of the second bending cylinder 61R such that the set bending pressure is obtained. The control device 100 repeats this feedback control until eliminating the state in which the deviation ΔTde or the corrected deviation ΔTd is more than the threshold value.

The sixth control formula is a control formula used when Tdc<Tc and Tdc<Tde are established. The sixth control formula determines control values that control the second gap adjusting mechanism 50R and the second bending mechanism 60R. When Tdc<Tc and Tdc<Tde are established, the thickness Tdc at the second intermediate portion 1DC is smaller than the thickness Tc at the center portion 1C and the thickness Tde at the end portion 1DE on the drive side. That is, the electrode sheet 1 undulates on the drive side such that a recess is formed at the second intermediate portion 1DC (see [second pattern] in FIG. 6).

For the sixth control formula, when the deviation ΔTdc is larger than the deviation ΔTde, and the corrected deviation ΔTd=ΔTdc×Ddc/Dde is more than the predetermined threshold value, or when the deviation ΔTde is equal to or more than the deviation ΔTdc, and the deviation ΔTde is more than the threshold value, the sixth control formula is configured to set the control value for the second gap adjusting mechanism 50R and the control value for the second bending mechanism 60R, the control value for the second gap adjusting mechanism 50R increasing the gap between the pair of rolling rolls 31, 32 on the drive side, the control value for the second bending mechanism 60R decreasing the gap between the pair of rolling rolls 31, 32 at the end portion 1DE on the drive side. The threshold value of the sixth control formula may be equal to or different from the threshold value of the fifth control formula.

The seventh control formula is a control formula used when Tc≤Tdc≤Tde is established. The seventh control formula determines control values that control the second gap adjusting mechanism 50R and the second bending mechanism 60R. When Tc≤Tdc≤ Tde is established, the thickness of the electrode sheet 1 on the drive side is the smallest at the center portion 1C, and increases with the increase in distance from the center portion 1C, that is, in order of the second intermediate portion 1DC and then the end portion 1DE on the drive side (see [third pattern] in FIG. 6).

For the seventh control formula, when the deviation ΔTde between the thickness Tc at the center portion 1C and the thickness Tde at the end portion 1DE on the drive side is more than the predetermined threshold value, the seventh control formula is configured to set the control value for the second bending mechanism 60R, the control value for the second bending mechanism 60R decreasing the gap between the pair of rolling rolls 31, 32 at the end portion 1DE on the drive side.

The eighth control formula is a control formula used when Tc≥Tdc≥Tde is established. The eighth control formula determines control values that control the second gap adjusting mechanism 50R and the second bending mechanism 60R. When Tc≥Tdc≥Tde is established, the thickness of the electrode sheet 1 on the drive side is the largest at the center portion 1C, and decreases with the increase in distance from the center portion 1C, that is, in order of the second intermediate portion 1DC and then the end portion 1DE on the drive side (see [fourth pattern] in FIG. 6).

For the eighth control formula, when the deviation ΔTde between the thickness Tc at the center portion 1C and the thickness Tde at the end portion 1DE on the drive side is more than the predetermined threshold value, the eighth control formula is configured to set the control value for the second bending mechanism 60R, the control value for the second bending mechanism 60R increasing the gap between the pair of rolling rolls 31, 32 at the end portion 1DE on the drive side.

As described above, the fifth control formula to the eighth control formula are control formulae for rectifying variation in thickness of the electrode sheet 1 on the drive side. The fifth control formula to the eighth control formula are respectively used in a first case, a second case, a third case, and a fourth case. In the first case, the electrode sheet 1 undulates such that a protrusion is formed at the second intermediate portion 1DC. In the second case, the electrode sheet 1 undulates such that a recess is formed at the second intermediate portion 1DC. In the third case, the thickness of the electrode sheet 1 increases toward the end portion 1DE on the drive side. In the fourth case, the thickness of the electrode sheet 1 decreases toward the end portion 1DE on the drive side. The control device 100 compares the measured values of the thickness Tc at the center portion 1C, the thickness Tde at the end portion 1DE on the drive side, and the thickness Tdc at the second intermediate portion 1DC and, based on the comparison result, judges which control formula of the fifth control formula to the eighth control formula should be used. The control device 100 determines the deviation ΔTde between the thickness Tc at the center portion 1C and the thickness Tde at the end portion 1DE on the drive side, and the deviation ΔTdc between the thickness Tc at the center portion 1C and the thickness Tdc at the second intermediate portion 1DC. When any of the fifth control formula to the eighth control formula is used, the control device 100 controls the second gap adjusting mechanism 50R and the second bending mechanism 60R in such a way as to reduce the deviation ΔTde or the deviation ΔTde, whichever is larger.

When the conveyance speed of the electrode sheet 1 conveyed by the conveyance device 20 is equal to or more than a predetermined threshold speed Vv (see FIG. 5), the execution judging unit 107 performs control of rectifying variation in thickness of the electrode sheet 1. However, when the conveyance speed of the electrode sheet 1 conveyed by the conveyance device 20 is lower than the threshold speed Vv, the execution judging unit 107 does not perform control of rectifying variation in thickness of the electrode sheet 1, and maintains rolling conditions. That is, when the conveyance speed of the electrode sheet 1 conveyed by the conveyance device 20 is equal to or more than the predetermined threshold speed Vv, the execution judging unit 107 controls the first gap adjusting mechanism 50L, the second gap adjusting mechanism 50R, the first bending mechanism 60L, and the second bending mechanism 60R in such a way as to reduce the deviation ΔTwe or the deviation ΔTwc, whichever is larger, and to reduce the deviation ΔTde or the deviation ΔTdc, whichever is larger. When the conveyance speed of the electrode sheet 1 conveyed by the conveyance device 20 is lower than the threshold speed Vv, the execution judging unit 107 maintains the control values for the first gap adjusting mechanism 50L, the second gap adjusting mechanism 50R, the first bending mechanism 60L, and the second bending mechanism 60R.

In the present embodiment, the control device 100 sets initial control values for the first gap adjusting mechanism 50L, the second gap adjusting mechanism 50R, the first bending mechanism 60L, and the second bending mechanism 60R based on the thickness Tc0 before rolling at the center portion 1C, the thickness Twe0 at the end portion 1WE on the work side, the thickness Tde0 at the end portion 1DE on the drive side, the thickness Twc0 at the first intermediate portion 1WC, and the thickness Tdc0 at the second intermediate portion 1DC. In the present embodiment, the control device 100 selects any of the first control formula to the fourth control formula, and any of the fifth control formula to the eighth control formula as control formulae to be used, based on the measured values of the thicknesses Tc0, Twe0, Tde0, Twc0, and Tdc0. The control device 100 uses control values calculated by the selected control formulae as initial values for starting rolling of a new electrode sheet 1. Consequently, it is possible to shorten the time period required for feedback control relating to rolling of the new electrode sheet 1 to stabilize (the time period required for variations in thickness of the new electrode sheet 1 to fall within an allowable range). As a result, it is possible to reduce the amount of the electrode sheet 1 being wasted during feedback control.

However, control formulae for setting the initial control values are not necessarily selected from the first control formula to the eighth control formula. The control formulae for setting the initial control values may be, for example, control formulae that are equal to the first control formula to the eighth control formula, but that have the amount of change in control value or have threshold values different from those in the first control formula to the eighth control formula.

### [Rolling Process for Electrode Sheet]

A rolling process for the electrode sheet 1 will be described hereinafter. FIG. 5 is a flowchart showing the flow of feedback control for the thickness of the electrode sheet 1. FIG. 5 shows the feedback control for one cycle, and this control is repeated in the rolling process for the electrode sheet 1. Setting of initial control values based on the measurement of the thicknesses of the electrode sheet 1 before rolling is substantially equal to that in the feedback control performed after rolling and hence, the description of the setting will be omitted.

As shown in FIG. 5, in the feedback control for the thickness of the electrode sheet 1, a conveyance speed V of the electrode sheet 1 is acquired in step S01. In step S02, the conveyance speed V of the electrode sheet 1 is compared with the predetermined threshold speed Vv. When the conveyance speed V of the electrode sheet 1 is equal to or more than the threshold speed Vv (when the result in step S02 is YES), thickness control for the electrode sheet 1 in step S03 and subsequent steps is performed. When the conveyance speed V of the electrode sheet 1 is lower than the threshold speed Vv (when the result in step S02 is NO), the thickness control for the electrode sheet 1 is not performed, and the control values at this point in time are maintained (END in FIG. 5). This is because when the conveyance speed V of the electrode sheet 1 is low, the electrode sheet 1 is sufficiently rolled, so that there is a small variation in thickness of the electrode sheet 1.

In step S03, with respect to the electrode sheet 1, the thickness Tc at the center portion 1C, the thickness Twe at the end portion 1WE on the work side, the thickness Tde at the end portion 1DE on the drive side, the thickness Twc at the first intermediate portion 1WC, and the thickness Tdc at the second intermediate portion 1DC are acquired. In step S04 to S06, it is judged that variation in thickness of the electrode sheet 1 on the work side follows which of four patterns. That is, it is judged that variation in thickness of the electrode sheet 1 follows which of the first pattern, the second pattern, the third pattern, and the fourth pattern, Twc>Tc and Twc>Twe being established in the first pattern (the pattern in which a protrusion is formed at the first intermediate portion 1WC), Twc<Tc and Twc<Twe being established in the second pattern (the pattern in which a recess is formed at the first intermediate portion 1WC), Tc≤Twc≤Twe being established in the third pattern (the pattern in which the thickness of the electrode sheet 1 increases toward the end portion), Tc≥Twc≥Twe being established in the fourth pattern (the pattern in which the thickness of the electrode sheet 1 decreases toward the end portion) (see FIG. 6, FIG. 6 is a schematic view showing distribution patterns of the thickness of the electrode sheet 1 according to the position in the width direction).

Although the order of step S04 to S06 is not particularly limited, in the example in FIG. 5, it is judged in step S04 whether Twc>Tc and Twc>Twe are established. When the result in step S04 is YES, it is decided in step S07A to use the first control formula. When the result in step S04 is NO, it is judged in step S05 whether Twc<Tc and Twc<Twe are established. When the result in step S05 is YES, it is decided in step S07B to use the second control formula. When the result in step S05 is NO, it is judged in step S06 whether Tc≤ Twc≤Twe is established. When the result in step S06 is YES, it is decided in step S07C to use the third control formula. When the result in step S06 is NO, it is decided in step S07D to use the fourth control formula.

In step S08A following step SO7A, the deviation ΔTwe between the thickness Tc at the center portion 1C and the thickness Twe at the end portion 1WE on the work side, and the deviation ΔTwc between the thickness Tc at the center portion 1C and the thickness Twc at the first intermediate portion 1WC are determined. In addition, in step S08A, the deviation ΔTwe (absolute value) is compared with the deviation ΔTwc (absolute value).

When the deviation ΔTwc for the first intermediate portion 1WC is larger than the deviation ΔTwe for the end portion 1WE on the work side (when the result in step S08A is YES), the corrected deviation ΔTw=ΔTwc×Dwc/Dwe is determined in step S09A1. In addition, in step S09A1, it is judged whether the corrected deviation ΔTw is more than the threshold value Vw1.

When the corrected deviation ΔTw is more than the threshold value Vw1 (when the result in step S09A1 is YES), in step S10A, the pressing pressure of the first press cylinder 51L is increased by a predetermined pressure, and the bending pressure of the first bending cylinder 61L is increased by a predetermined pressure. When the corrected deviation ΔTw is not more than the threshold value Vw1 (when the result in step S09A1 is NO), the pressing pressure of the first press cylinder 51L and the bending pressure of the first bending cylinder 61L are maintained (END in FIG. 5).

Returning to step S08A, when the deviation ΔTwe for the end portion 1WE on the work side is larger than the deviation ΔTwc for the first intermediate portion 1WC (when the result in step S08A is NO), it is judged in step S09A2 whether the deviation ΔTwe is more than the threshold value Vw1.

When the deviation ΔTwe is more than the threshold value Vw1 (when the result in step S09A2 is YES), in step S10A, the pressing pressure of the first press cylinder 51L is increased by a predetermined pressure, and the bending pressure of the first bending cylinder 61L is increased by a predetermined pressure. When the deviation ΔTwe is not more than the threshold value Vw1 (when the result in step S09A2 is NO), the pressing pressure of the first press cylinder 51L and the bending pressure of the first bending cylinder 61L are maintained (END in FIG. 5).

When it is decided to use the second control formula, in step S08B following step S07B, the deviation ΔTwe between the thickness Tc at the center portion 1C and the thickness Twe at the end portion 1WE on the work side, and the deviation ΔTwc between the thickness Tc at the center portion 1C and the thickness Twc at the first intermediate portion 1WC are determined. In addition, in step S08B, the deviation ΔTwe (absolute value) is compared with the deviation ΔTwc (absolute value). Step S08B is substantially equal to step S08A.

When the deviation ΔTwc for the first intermediate portion 1WC is larger than the deviation ΔTwe for the end portion 1WE on the work side (when the result in step S08B is YES), the corrected deviation ΔTw=ΔTwc×Dwc/Dwe is determined in step S09B1. In addition, in step S09B1, it is judged whether the corrected deviation ΔTw is more than the threshold value Vw2. Step S09B1 is substantially equal to step S09A1.

When the corrected deviation ΔTw is more than the threshold value Vw2 (when the result in step S09B1 is YES), in step S10B, the pressing pressure of the first press cylinder 51L is decreased by a predetermined pressure, and the bending pressure of the first bending cylinder 61L is decreased by a predetermined pressure. The directions in which pressing pressure and bending pressure change in step S10B are opposite to those in step S10A. When the corrected deviation ΔTw is not more than the threshold value Vw2 (when the result in step S09B1 is NO), the pressing pressure of the first press cylinder 51L and the bending pressure of the first bending cylinder 61L are maintained (END in FIG. 5).

Returning to step S08B, when the deviation ΔTwe for the end portion 1WE on the work side is larger than the deviation ΔTwc for the first intermediate portion 1WC (when the result in step S08B is NO), it is judged in step S09B2 whether the deviation ΔTwe is more than the threshold value Vw2.

When the deviation ΔTwe is more than the threshold value Vw2 (when the result in step S09B2 is YES), in step S10B, the pressing pressure of the first press cylinder 51L is decreased by a predetermined pressure, and the bending pressure of the first bending cylinder 61L is decreased by a predetermined pressure. When the deviation ΔTwe is not more than the threshold value Vw2 (when the result in step S09B2 is NO), the pressing pressure of the first press cylinder 51L and the bending pressure of the first bending cylinder 61L are maintained (END in FIG. 5).

When it is decided to use the third control formula, in step S08C following step S07C, the deviation ΔTwe between the thickness Tc at the center portion 1C and the thickness Twe at the end portion 1WE on the work side is determined. In step S09C, it is judged whether the deviation ΔTwe is more than the threshold value Vw3. When the deviation ΔTwe is more than the threshold value Vw3 (when the result in step S09C is YES), in step S10C, the bending pressure of the first bending cylinder 61L is decreased by a predetermined pressure. When the deviation ΔTwe is not more than the threshold value Vw3 (when the result in step S09C is NO), the pressing pressure of the first press cylinder 51L and the bending pressure of the first bending cylinder 61L are maintained (END in FIG. 5).

When it is decided to use the fourth control formula, in step S08D following step S07D, the deviation ΔTwe between the thickness Tc at the center portion 1C and the thickness Twe at the end portion 1WE on the work side is determined. Step S08D is substantially equal to step S08C. In step S09D, it is judged whether the deviation ΔTwe is more than the threshold value Vw4. When the deviation ΔTwe is more than the threshold value Vw4 (when the result in step S09D is YES), in step S10D, the bending pressure of the first bending cylinder 61L is increased by a predetermined pressure. When the deviation ΔTwe is not more than the threshold value Vw4 (when the result in step S09D is NO), the pressing pressure of the first press cylinder 51L and the bending pressure of the first bending cylinder 61L are maintained (END in FIG. 5).

Thickness control on the drive side is also performed in the same manner as that on the work side. Therefore, the illustration and the description in the flowchart will be omitted.

### Advantageous Effects of Embodiment

Hereinafter, advantageous effects that can be obtained by the electrode rolling device 10 according to the present embodiment will be described.

The electrode rolling device 10 according to the present embodiment includes the conveyance device 20 configured to convey, along the predetermined conveyance path, the electrode sheet 1 which has a strip shape and on which the electrode active material layer 3 is formed, the roll press machine 30 disposed in the conveyance path and configured to roll the electrode sheet 1, and the control device 100. The roll press machine 30 includes the pair of rolling rolls 31, 32 allowing the electrode sheet 1 to be interposed therebetween, the first gap adjusting mechanism 50L configured to adjust the gap between the pair of rolling rolls 31, 32 on the work side of the pair of rolling rolls 31, 32 in the width direction, the second gap adjusting mechanism 50R configured to adjust the gap between the pair of rolling rolls 31, 32 on the drive side of the pair of rolling rolls 31, 32 in the width direction, the first bending mechanism 60L configured to rectify deflection of the pair of rolling rolls 31, 32 on the work side of the pair of rolling rolls 31, 32, and the second bending mechanism 60R configured to rectify deflection of the pair of rolling rolls 31, 32 on the drive side of the pair of rolling rolls 31, 32. The control device 100 acquires, with respect to the electrode sheet 1, the thickness Tc at the center portion 1C in the width direction, the thickness Twe at the end portion 1WE on the work side, the thickness Tde at the end portion 1DE on the drive side, the thickness Twc at the first intermediate portion 1WC, which is set between the center portion 1C and the end portion 1WE on the work side, and the thickness Tdc at the second intermediate portion 1DC, which is set between the center portion 1C and the end portion 1DE on the drive side. The control device 100 determines the deviation ΔTwe between the thickness Tc at the center portion 1C and the thickness Twe at the end portion 1WE on the work side, and the deviation ΔTwc between the thickness Tc at the center portion 1C and the thickness Twc at the first intermediate portion 1WC, and determines the deviation ΔTde between the thickness Tc at the center portion 1C and the thickness Tde at the end portion 1DE on the drive side, and the deviation ΔTdc between the thickness Tc at the center portion 1C and the thickness Tdc at the second intermediate portion 1DC. The control device 100 controls the first gap adjusting mechanism 50L, the second gap adjusting mechanism 50R, the first bending mechanism 60L, and the second bending mechanism 60R in such a way as to reduce the deviation ΔTwe or the deviation ΔTwc, whichever is larger, and to reduce the deviation ΔTde or the deviation ΔTdc, whichever is larger.

According to the electrode rolling device 10, the first gap adjusting mechanism 50L, the second gap adjusting mechanism 50R, the first bending mechanism 60L, and the second bending mechanism 60R are controlled in such a way as to reduce whichever is the larger of the deviation ΔTwe or the deviation ΔTwc (ΔTwe is the deviation between the thickness Tc of the electrode sheet 1 at the center portion 1C in the width direction and the thickness Twe at the end portion 1WE on the work side. The deviation ΔTwc is the deviation between the thickness Tc at the center portion 1C and the thickness Twc at the first intermediate portion 1WC), and to reduce whichever is the larger of the deviation ΔTde or the deviation ΔTdc (ΔTde is the deviation between the thickness Tc at the center portion 1C and the thickness Tde at the end portion 1DE on the drive side. The deviation ΔTdc is the deviation between the thickness Tc at the center portion 1C and the thickness Tdc at the second intermediate portion 1DC). Therefore, even when the first intermediate portion 1WC or the second intermediate portion 1DC has a large thickness or a small thickness due to undulation, it is possible to reduce variation in thickness of the electrode sheet 1 along the width direction.

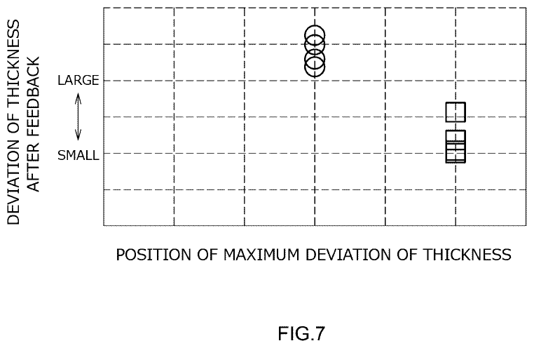

FIG. 7 is a graph showing the maximum deviation of the thickness of the electrode sheet 1. The vertical axis in FIG. 7 shows the maximum deviation of the thickness of the electrode sheet 1. The horizontal axis in FIG. 7 shows the position at which deviation of the thickness of the electrode sheet 1 is maximum. In FIG. 7, conventional control shown by circles is obtained by plotting the results of control based on control formulae equal to the control formulae 3, 4, 7, and 8. In FIG. 7, control shown by squares is obtained by plotting the results of control performed by a control method according to the present embodiment. As shown in FIG. 7, with the control method according to the present embodiment, the maximum deviation of the thickness of the electrode sheet 1 is reduced compared with that obtained with the conventional control. That is, variation in thickness is suppressed.

In the present embodiment, the control device 100 stores the first control formula to the fourth control formula. The first control formula is used when Twc>Tc and Twc>Twe are established. The first control formula determines control values that control the first gap adjusting mechanism 50L and the first bending mechanism 60L. The second control formula is used when Twc<Tc and Twc<Twe are established. The second control formula determines control values that control the first gap adjusting mechanism 50L and the first bending mechanism 60L. The third control formula is used when Tc≤Twc≤Twe is established. The third control formula determines control values that control the first gap adjusting mechanism 50L and the first bending mechanism 60L. The fourth control formula is used when Tc>Twc>Twe is established. The fourth control formula determines control values that control the first gap adjusting mechanism 50L and the first bending mechanism 60L.

With such a configuration, four control formulae are selectively used corresponding to four patterns of variation in thickness on the work side. Consequently, when any one of the four patterns occurs as the pattern of variation in thickness on the work side, it is possible to reduce variation in thickness of the electrode sheet 1 along the width direction. The same applies for the drive side.

In the present embodiment, the first bending mechanism 60L is configured to change the gap between the pair of rolling rolls 31, 32 at the end portion 1WE on the work side. For the first control formula, taking the distance in the width direction between the center portion 1C and the end portion 1WE on the work side as “Dwe”, and taking the distance in the width direction between the center portion 1C and the first intermediate portion 1WC as “Dwc”, when the deviation ΔTwc is larger than the deviation ΔTwe, and the corrected deviation ΔTw=ΔTwc×Dwc/Dwe is more than the predetermined threshold value Vw1, or when the deviation ΔTwe is equal to or more than the deviation ΔTwc, and the deviation ΔTwe is more than the threshold value Vw1, the first control formula is configured to set the control value for the first gap adjusting mechanism 50L and the control value for the first bending mechanism 60L, the control value for the first gap adjusting mechanism 50L decreasing the gap between the pair of rolling rolls 31, 32 on the work side, the control value for the first bending mechanism 60L increasing the gap between the pair of rolling rolls 31, 32 at the end portion 1WE on the work side.

With such a configuration, the deviation ΔTwe or the deviation ΔTwc, whichever is larger is compared with the threshold value Vw1. As a result, control is performed in such a way as to rectify the deviation ΔTwe or the deviation ΔTwc, whichever is larger and hence, it is possible to reduce variation in thickness of the electrode sheet 1 along the width direction. When the deviation ΔTwc for the first intermediate portion 1WC is larger than the deviation ΔTwe for the end portion 1WE on the work side, the corrected deviation ΔTw=ΔTwc X Dwc/Dwe obtained by correcting the deviation ΔTwc for the first intermediate portion 1WC is compared with the threshold value Vw1. The corrected deviation ΔTw represents the amount of deflection at the first intermediate portion 1WC with the end portion 1WE on the work side deflected. By using the corrected deviation ΔTw, it is possible to appropriately determine the amount of change in the bending pressure of the first bending mechanism 60L. The same applies for the drive side.

In the present embodiment, for the second control formula, when the deviation ΔTwc is larger than the deviation ΔTwe, and the corrected deviation ΔTw=ΔTwc×Dwc/Dwe is more than the predetermined threshold value Vw2, or when the deviation ΔTwe is equal to or more than the deviation ΔTwc, and the deviation ΔTwe is more than the threshold value Vw2, the second control formula is configured to set the control value for the first gap adjusting mechanism 50L and the control value for the first bending mechanism 60L, the control value for the first gap adjusting mechanism 50L increasing the gap between the pair of rolling rolls 31, 32 on the work side, the control value for the first bending mechanism 60L decreasing the gap between the pair of rolling rolls 31, 32 at the end portion 1WE on the work side.

With such a configuration, although the direction in which the thickness is rectified is opposite to that for the case of the first control formula, it is possible to obtain advantageous effects substantially equal to those for the case of the first control formula. The same applies for the drive side.

In the present embodiment, when the conveyance speed V of the electrode sheet 1 conveyed by the conveyance device 20 is equal to or more than the predetermined threshold speed Vv, the control device 100 controls the first gap adjusting mechanism 50L, the second gap adjusting mechanism 50R, the first bending mechanism 60L, and the second bending mechanism 60R in such a way as to reduce the deviation ΔTwe or the deviation ΔTwc, whichever is larger, and to reduce the deviation ΔTde or the deviation ΔTde, whichever is larger. When the conveyance speed V of the electrode sheet 1 conveyed by the conveyance device 20 is lower than the threshold speed Vv, the control device 100 maintains the control values for the first gap adjusting mechanism 50L, the second gap adjusting mechanism 50R, the first bending mechanism 60L, and the second bending mechanism 60R.

According to the findings of the inventors of the present application, when the conveyance speed V of the electrode sheet 1 is low, the electrode sheet 1 is sufficiently rolled, so that variation in thickness of the electrode sheet 1 is small. With the above-mentioned configuration, when the conveyance speed V of the electrode sheet 1 is lower than the threshold speed Vv, thickness variation control may be omitted.

The electrode rolling device 10 according to the present embodiment includes, at a position downstream of the roll press machine 30 in the conveyance path, the downstream-side thickness measuring device 80 configured to measure, with respect to the electrode sheet 1 after rolling, the thickness Tc at the center portion 1C, the thickness Twe at the end portion 1WE on the work side, the thickness Tde at the end portion 1DE on the drive side, the thickness Twc at the first intermediate portion 1WC, and the thickness Tdc at the second intermediate portion 1DC.

With such a configuration, the control device 100 can acquire, with respect to the electrode sheet 1 after rolling, the thickness Tc at the center portion 1C, the thickness Twe at the end portion 1WE on the work side, the thickness Tde at the end portion 1DE on the drive side, the thickness Twc at the first intermediate portion 1WC, and the thickness Tdc at the second intermediate portion 1DC.

The electrode rolling device 10 according to the present embodiment includes, at a position upstream of the roll press machine 30 in the conveyance path, the upstream-side thickness measuring device 70 configured to measure, with respect to the electrode sheet 1 before rolling, the thickness Tc0 at the center portion 1C, the thickness Twe0 at the end portion 1WE on the work side, the thickness Tde0 at the end portion 1DE on the drive side, the thickness Twc0 at the first intermediate portion 1WC, and the thickness Tdc0 at the second intermediate portion 1DC. Based on the thicknesses Tc0, Twe0, Tde0, Twc0, and Tdc0, the control device 100 sets initial control values for the first gap adjusting mechanism 50L, the second gap adjusting mechanism 50R, the first bending mechanism 60L, and the second bending mechanism 60R.

With such a configuration, it is possible to shorten the time period so that the feedback control relating to rolling of a new electrode sheet 1 is stabilized and variations in thickness of the electrode sheet 1 falls within an allowable range. As a result, it is possible to reduce the amount of the electrode sheet 1 being wasted during the feedback control.

### Another Embodiment

One embodiment of the rolling device for the electrode sheet proposed herein has been described heretofore. However, the above-mentioned embodiment is merely an example, and the rolling device for the electrode sheet may be performed by another mode. For example, in the above-mentioned embodiment, the thicknesses of the electrode sheet are measured at five different points in the width direction of the electrode sheet, and thickness variation control is performed based on the thicknesses measured at the five points. However, the number of points at which the thicknesses are measured for performing the thickness variation control based on the measured values may be six or more.

In the above-mentioned embodiment, the feedforward control is performed based on the measured thicknesses of the electrode sheet before rolling. However, the feedforward control need not be performed. In the above-mentioned embodiment, the feedback control is not performed in the case in which the conveyance speed of the electrode sheet is low. However, the feedback control may be performed also in the case in which the conveyance speed of the electrode sheet is low. In such a case, control formulae may be changed according to the conveyance speed of the electrode sheet. For example, control formulae for such a case may be control formulae that continuously or stepwisely reduce the amount of change in the pressing pressure of the gap adjusting mechanism and the amount of change in the bending pressure of the bending mechanism with a decrease in the conveyance speed of the electrode sheet.

The above-mentioned embodiment does not limit the present invention unless otherwise specified. Furthermore, various modifications of the technology disclosed herein are conceivable. The respective constitutional elements and the respective processes mentioned herein may be suitably omitted or suitably combined provided that no particular problem is caused.

The present specification includes disclosures described in the following Items.

### Item 1:

An electrode rolling device including:
a conveyance device configured to convey, along the predetermined conveyance path, the electrode sheet which has the strip shape and on which the electrode active material layer is formed;
the rolling device disposed in the predetermined conveyance path, and configured to roll the electrode sheet; and

the controller, wherein
the rolling device includes the pair of rolling rolls allowing the electrode sheet to be interposed
therebetween, the first gap adjusting mechanism configured to adjust the gap between the
pair of rolling rolls on the first side of the pair of rolling rolls in the width direction, the second gap adjusting mechanism configured to adjust the gap between the
pair of rolling rolls on the second side of the pair of rolling rolls in the width direction, the first bending mechanism configured to rectify deflection of the pair of
rolling rolls on the first side of the pair of rolling rolls in the width direction, and the second bending mechanism configured to rectify the deflection of the pair of rolling rolls on the second side of the pair of rolling rolls in the width direction, and

the controller is configured to:
acquire, with respect to the electrode sheet,
   the thickness Tc at the center portion in the width direction,
   the thickness Twe at the end portion on the first side,
   the thickness Tde at the end portion on the second side,
   the thickness Twc at the first intermediate portion, which is set between the center portion and the end portion on the first side, and
   the thickness Tdc at the second intermediate portion, which is set between the center portion and the end portion on the second side;
determine the deviation ΔTwe between the thickness Tc at the center portion and the thickness Twe at the end portion on the first side, and the deviation ΔTwc between the thickness Tc at the center portion and the thickness Twc at the first intermediate portion;
determine the deviation ΔTde between the thickness Tc at the center portion and the thickness Tde at the end portion on the second side, and the deviation ΔTdc between the thickness Tc at the center portion and the thickness Tdc at the second intermediate portion; and
control the first gap adjusting mechanism, the second gap adjusting mechanism, the first bending mechanism, and the second bending mechanism in such a way as to reduce the deviation ΔTwe or the deviation ΔTwc, whichever is larger, and to reduce the deviation ΔTde or the deviation ΔTde, whichever is larger.

### Item 2:

The electrode rolling device according to Item 1, wherein

the controller stores
the first control formula used when Twc>Tc and Twc>Twe are established, the first control formula determining the control value that controls the first gap adjusting mechanism and determining the control value that controls the first bending mechanism,
the second control formula used when Twc<Tc and Twc<Twe are established, the second control formula determining the control value that controls the first gap adjusting mechanism and determining the control value that controls the first bending mechanism,
the third control formula used when Tc≤Twc≤Twe is established, the third control formula determining the control value that controls the first gap adjusting mechanism and determining the control value that controls the first bending mechanism, and
the fourth control formula used when Tc>Twc>Twe is established, the fourth control formula determining the control value that controls the first gap adjusting mechanism and determining the control value that controls the first bending mechanism.

### Item 3:

The electrode rolling device according to Item 2, wherein

the first bending mechanism is configured to change the gap between the pair of rolling rolls at the end portion on the first side, and

for the first control formula,
taking the distance in the width direction between the center portion and the end portion on the first side as “Dwe”, and
taking the distance in the width direction between the center portion and the first intermediate portion as “Dwc”,
when the deviation ΔTwc is larger than the deviation ΔTwe, and the corrected deviation ΔTw=ΔTwc×Dwc/Dwe is more than the predetermined threshold value, or when the deviation ΔTwe is equal to or more than the deviation ΔTwc, and the deviation ΔTwe is more than the predetermined threshold value, the first control formula is configured to set the control value for the first gap adjusting mechanism and the control value for the first bending mechanism, the control value for the first gap adjusting mechanism decreasing the gap between the pair of rolling rolls on the first side, the control value for the first bending mechanism increasing the gap between the pair of rolling rolls at the end portion on the first side.

### Item 4:

The electrode rolling device according to Item 2 or 3, wherein

the first bending mechanism is configured to change the gap between the pair of rolling rolls at the end portion on the first side, and

for the second control formula,
taking the distance in the width direction between the center portion and the end portion on the first side as “Dwe”, and
taking the distance in the width direction between the center portion and the first intermediate portion as “Dwc”,
when the deviation ΔTwc is larger than the deviation ΔTwe, and the corrected deviation ΔTw=ΔTwc×Dwc/Dwe is more than the predetermined threshold value, or when the deviation ΔTwe is equal to or more than the deviation ΔTwc, and the deviation ΔTwe is more than the predetermined threshold value, the second control formula is configured to set the control value for the first gap adjusting mechanism and the control value for the first bending mechanism, the control value for the first gap adjusting mechanism increasing the gap between the pair of rolling rolls on the first side, the control value for the first bending mechanism decreasing the gap between the pair of rolling rolls at the end portion on the first side.

Item 5: The electrode rolling device according to any one of Items 1 to 4, wherein

the controller stores
the fifth control formula that is used when Tdc>Tc and Tdc>Tde are established, the fifth control formula determining the control value that controls the second gap adjusting mechanism and determining the control value that controls the second bending mechanism,
the sixth control formula that is used when Tdc<Tc and Tdc<Tde are established, the sixth control formula determining the control value that controls the second gap adjusting mechanism and determining the control value that controls the second bending mechanism,
the seventh control formula that is used when Tc≤Tdc≤Tde is established, the seventh control formula determining the control value that controls the second gap adjusting mechanism and determining the control value that controls the second bending mechanism, and
the eighth control formula that is used when Tc≥Tdc≥Tde is established, the eighth control formula determining the control value that controls the second gap adjusting mechanism and determining the control value that controls the second bending mechanism.

### Item 6:

The electrode rolling device according to Item 5, wherein the second bending mechanism is configured to change the gap between the pair of rolling rolls at the end portion on the second side, and

for the fifth control formula,
taking the distance in the width direction between the center portion and the end portion on the second side as “Dde”, and
taking the distance in the width direction between the center portion and the second intermediate portion as “Ddc”,
when the deviation ΔTdc is larger than the deviation ΔTde, and the corrected deviation ΔTd=ΔTdc×Ddc/Dde is more than the predetermined threshold value, or when the deviation ΔTde is equal to or more than the deviation ΔTdc, and the deviation ΔTde is more than the predetermined threshold value, the fifth control formula is configured to set the control value for the second gap adjusting mechanism and the control value for the second bending mechanism, the control value for the second gap adjusting mechanism decreasing the gap between the pair of rolling rolls on the second side, the control value for the second bending mechanism increasing the gap between the pair of rolling rolls at the end portion on the second side.

### Item 7:

The electrode rolling device according to Item 5 or 6, wherein

the second bending mechanism is configured to change the gap between the pair of rolling rolls at the end portion on the second side, and

for the sixth control formula,
taking the distance in the width direction between the center portion and the end portion on the second side as “Dde”, and
taking the distance in the width direction between the center portion and the second intermediate portion as “Ddc”,
when the deviation ΔTdc is larger than the deviation ΔTde, and the corrected deviation ΔTd=ΔTdc×Ddc/Dde is more than the predetermined threshold value, or when the deviation ΔTde is equal to or more than the deviation ΔTdc, and the deviation ΔTde is more than the predetermined threshold value, the sixth control formula is configured to set the control value for the second gap adjusting mechanism and the control value for the second bending mechanism, the control value for the second gap adjusting mechanism increasing the gap between the pair of rolling rolls on the second side, the control value for the second bending mechanism decreasing the gap between the pair of rolling rolls at the end portion on the second side.
   Item 8: The electrode rolling device according to any one of Items 1 to 7, wherein

the controller is configured to:

when the conveyance speed of the electrode sheet conveyed by the conveyance device is equal to or more than the predetermined threshold speed, control the first gap adjusting mechanism, the second gap adjusting mechanism, the first bending mechanism, and the second bending mechanism in such a way as to reduce the deviation ΔTwe or the deviation ΔTwc, whichever is larger, and to reduce the deviation ΔTde or the deviation ΔTdc, whichever is larger; and

when the conveyance speed of the electrode sheet conveyed by the conveyance device is lower than the predetermined threshold speed, maintain the control value for the first gap adjusting mechanism, the control value for the second gap adjusting mechanism, the control value for the first bending mechanism, and the control value for the second bending mechanism.

Item 9: The electrode rolling device according to any one of Items 1 to 8, further comprising, at the position downstream of the rolling device in the predetermined conveyance path, the first thickness measuring device configured to measure, with respect to the electrode sheet after rolling, the thickness Tc at the center portion, the thickness Twe at the end portion on the first side, the thickness Tde at the end portion on the second side, the thickness Twc at the first intermediate portion, and the thickness Tdc at the second intermediate portion.
Item 10: The electrode rolling device according to any one of Items 1 to 9, further comprising, at the position upstream of the rolling device in the predetermined conveyance path, the second thickness measuring device configured to measure, with respect to the electrode sheet before rolling, the thickness Tc0 at the center portion, the thickness Twe0 at the end portion on the first side, the thickness Tde0 at the end portion on the second side, the thickness Twc0 at the first intermediate portion, and the thickness Tdc0 at the second intermediate portion, wherein

the controller sets the initial control value for the first gap adjusting mechanism, the initial control value for the second gap adjusting mechanism, the initial control value for the first bending mechanism, and the initial control value for the second bending mechanism based on the thickness Tc0, the thickness Twe0, the thickness Tde0, the thickness Twc0, and the thickness Tdc0.

What is claimed is:

1. An electrode rolling device comprising:
a conveyance device configured to convey, along a predetermined conveyance path, an electrode sheet which has a strip shape and on which an electrode active material layer is formed;
a rolling device disposed in the predetermined conveyance path, and
configured to roll the electrode sheet; and
a controller, wherein
the rolling device includes a pair of rolling rolls allowing the electrode sheet to be interposed therebetween,
a first gap adjusting mechanism configured to adjust a gap between the pair of rolling rolls on a first side of the pair of rolling rolls in a width direction,
a second gap adjusting mechanism configured to adjust the gap between the pair of rolling rolls on a second side of the pair of rolling rolls in the width direction,
a first bending mechanism configured to rectify deflection of the pair of rolling rolls on the first side of the pair of rolling rolls in the width direction, and
a second bending mechanism configured to rectify the deflection of the pair of rolling rolls on the second side of the pair of rolling rolls in the width direction, and the controller is configured to:
acquire, with respect to the electrode sheet,
a thickness Tc at a center portion in the width direction,
a thickness Twe at an end portion on the first side,
a thickness Tde at an end portion on the second side,
a thickness Twc at a first intermediate portion, which is set between the center portion and the end portion on the first side, and
a thickness Tdc at a second intermediate portion, which is set between the center portion and the end portion on the second side;
determine a deviation ΔTwe between the thickness Tc at the center portion and the thickness Twe at the end portion on the first side, and a deviation ΔTwc between the thickness Tc at the center portion and the thickness Twc at the first intermediate portion;
determine a deviation ΔTde between the thickness Tc at the center portion and the thickness Tde at the end portion on the second side, and a deviation ΔTdc between the thickness Tc at the center portion and the thickness Tdc at the second intermediate portion; and
control the first gap adjusting mechanism, the second gap adjusting mechanism, the first bending mechanism, and the second bending mechanism in such a way as to reduce the deviation ΔTwe or the deviation ΔTwc, whichever is larger, and to reduce the deviation ΔTde or the deviation ΔTdc, whichever is larger.

2. The electrode rolling device according to claim 1, wherein
the controller stores
a first control formula used when Twc>Tc and Twc>Twe are established, the first control formula determining a control value that controls the first gap adjusting mechanism and determining a control value that controls the first bending mechanism,
a second control formula used when Twc<Tc and Twc<Twe are established, the second control formula determining a control value that controls the first gap adjusting mechanism and determining a control value that controls the first bending mechanism,
a third control formula used when Tc≤Twc≤Twe is established, the third control formula determining a control value that controls the first gap adjusting mechanism and determining a control value that controls the first bending mechanism, and
a fourth control formula used when Tc>Twc>Twe is established, the fourth control formula determining a control value that controls the first gap adjusting mechanism and determining a control value that controls the first bending mechanism.

3. The electrode rolling device according to claim 2, wherein
the first bending mechanism is configured to change the gap between the pair of rolling rolls at the end portion on the first side, and
for the first control formula,
taking a distance in the width direction between the center portion and the end portion on the first side as “Dwe”, and
taking a distance in the width direction between the center portion and the first intermediate portion as “Dwc”,
when the deviation ΔTwc is larger than the deviation ΔTwe, and a corrected deviation ΔTw=ΔTwc×Dwc/Dwe is more than a predetermined threshold value, or when the deviation ΔTwe is equal to or more than the deviation ΔTwc, and the deviation ΔTwe is more than the predetermined threshold value, the first control formula is configured to set the control value for the first gap adjusting mechanism and the control value for the first bending mechanism, the control value for the first gap adjusting mechanism decreasing the gap between the pair of rolling rolls on the first side, the control value for the first bending mechanism increasing the gap between the pair of rolling rolls at the end portion on the first side.

4. The electrode rolling device according to claim 2, wherein
the first bending mechanism is configured to change the gap between the pair of rolling rolls at the end portion on the first side, and
for the second control formula,
taking a distance in the width direction between the center portion and the end portion on the first side as “Dwe”, and
taking a distance in the width direction between the center portion and the first intermediate portion as “Dwc”,
when the deviation ΔTwc is larger than the deviation ΔTwe, and a corrected deviation ΔTw=ΔTwc×Dwc/Dwe is more than a predetermined threshold value, or when the deviation ΔTwe is equal to or more than the deviation ΔTwc, and the deviation ΔTwe is more than the predetermined threshold value, the second control formula is configured to set the control value for the first gap adjusting mechanism and the control value for the first bending mechanism, the control value for the first gap adjusting mechanism increasing the gap between the pair of rolling rolls on the first side, the control value for the first bending mechanism decreasing the gap between the pair of rolling rolls at the end portion on the first side.

5. The electrode rolling device according to claim 1, wherein
the controller stores
a fifth control formula that is used when Tdc>Tc and Tdc>Tde are established, the fifth control formula determining a control value that controls the second gap adjusting mechanism and determining a control value that controls the second bending mechanism,
a sixth control formula that is used when Tdc<Tc and Tdc<Tde are established, the sixth control formula determining a control value that controls the second gap adjusting mechanism and determining a control value that controls the second bending mechanism,
a seventh control formula that is used when Tc≤Tdc≤Tde is established, the seventh control formula determining a control value that controls the second gap adjusting mechanism and determining a control value that controls the second bending mechanism, and
an eighth control formula that is used when Tc>Tdc>Tde is established, the eighth control formula determining a control value that controls the second gap adjusting mechanism and determining a control value that controls the second bending mechanism.

6. The electrode rolling device according to claim 5, wherein
the second bending mechanism is configured to change the gap between the pair of rolling rolls at the end portion on the second side, and
for the fifth control formula,
taking a distance in the width direction between the center portion and the end portion on the second side as “Dde”, and
taking a distance in the width direction between the center portion and the second intermediate portion as “Ddc”,
when the deviation ΔTdc is larger than the deviation ΔTde, and a corrected deviation ΔTd=ΔTdc×Ddc/Dde is more than a predetermined threshold value, or when the deviation ΔTde is equal to or more than the deviation ΔTdc, and the deviation ΔTde is more than the predetermined threshold value, the fifth control formula is configured to set the control value for the second gap adjusting mechanism and the control value for the second bending mechanism, the control value for the second gap adjusting mechanism decreasing the gap between the pair of rolling rolls on the second side, the control value for the second bending mechanism increasing the gap between the pair of rolling rolls at the end portion on the second side.

7. The electrode rolling device according to claim 5, wherein
the second bending mechanism is configured to change the gap between the pair of rolling rolls at the end portion on the second side, and
for the sixth control formula,
taking a distance in the width direction between the center portion and the end portion on the second side as “Dde”, and
taking a distance in the width direction between the center portion and the second intermediate portion as “Ddc”,
when the deviation ΔTdc is larger than the deviation ΔTde, and a corrected deviation ΔTd=ΔTdc×Ddc/Dde is more than a predetermined threshold value, or when the deviation ΔTde is equal to or more than the deviation ΔTdc, and the deviation ΔTde is more than the predetermined threshold value, the sixth control formula is configured to set the control value for the second gap adjusting mechanism and the control value for the second bending mechanism, the control value for the second gap adjusting mechanism increasing the gap between the pair of rolling rolls on the second side, the control value for the second bending mechanism decreasing the gap between the pair of rolling rolls at the end portion on the second side.

8. The electrode rolling device according to claim 1, wherein
the controller is configured to:
when a conveyance speed of the electrode sheet conveyed by the conveyance device is equal to or more than a predetermined threshold speed, control the first gap adjusting mechanism, the second gap adjusting mechanism, the first bending mechanism, and the second bending mechanism in such a way as to reduce the deviation ΔTwe or the deviation ΔTwc, whichever is larger, and to reduce the deviation ΔTde or the deviation ΔTdc, whichever is larger; and
when the conveyance speed of the electrode sheet conveyed by the conveyance device is lower than the predetermined threshold speed, maintain a control value for the first gap adjusting mechanism, a control value for the second gap adjusting mechanism, a control value for the first bending mechanism, and a control value for the second bending mechanism.

9. The electrode rolling device according to claim 1, further comprising, at a position downstream of the rolling device in the predetermined conveyance path, a first thickness measuring device configured to measure, with respect to the electrode sheet after rolling, the thickness Tc at the center portion, the thickness Twe at the end portion on the first side, the thickness Tde at the end portion on the second side, the thickness Twc at the first intermediate portion, and the thickness Tdc at the second intermediate portion.

10. The electrode rolling device according to claim 1, further comprising, at a position upstream of the rolling device in the predetermined conveyance path, a second thickness measuring device configured to measure, with respect to the electrode sheet before rolling, a thickness Tc0 at the center portion, a thickness Twe0 at the end portion on the first side, a thickness Tde0 at the end portion on the second side, a thickness Twc0 at the first intermediate portion, and a thickness Tdc0 at the second intermediate portion, wherein
the controller sets an initial control value for the first gap adjusting mechanism, an initial control value for the second gap adjusting mechanism, an initial control value for the first bending mechanism, and an initial control value for the second bending mechanism based on the thickness Tc0, the thickness Twe0, the thickness Tde0, the thickness Twc0, and the thickness Tdc0.
